(19) United States
(12) Patent Application Publication
(10) Pub. No.: US 2014/0261191 A1
(43) Pub. Date: Sep. 18, 2014

(54) MATERIALS AND METHODS TO PREVENT LINEAR FOREIGN BODIES

(71) Applicant: Cheryl Anne Laite, Nepean (CA)

(72) Inventor: Cheryl Anne Laite, Nepean (CA)

(21) Appl. No.: 14/181,064

(22) Filed: Feb. 14, 2014

Related U.S. Application Data
(60) Provisional application No. 61/765,658, filed on Feb. 15, 2013.

(51) Int. Cl. A01K 1/035

(52) U.S. Cl. CPC A01K 1/0353
USPC 119/28.5; 112/475.08

(57) ABSTRACT

Described herein are animal or pet accessories, such as animal beds, puppy pads, and pet toys, which are designed to prevent complications associated with consuming linear foreign bodies, and which are produced using materials which are semi- to fully digestible. Also provided is a stitching method for such accessories, in which stitching is carried out in increments safe for consumption by an animal, and using a stitching material which is semi- to fully digestible.

### FIELD OF INVENTION

The present invention relates to accessories or products for animals, such as beds, absorbent pads, toys and the like, as well as methods for the production thereof. In particular, the present invention relates to animal products and accessories that are made of materials that are semi- to fully digestible, and can reduce or prevent gastrointestinal obstructions or complications associated with linear foreign bodies.

### BACKGROUND OF THE INVENTION

It is relatively common for foreign bodies to be ingested by animals, especially dogs and cats. Dogs in particular will chew and ingest toys, bones, bedding, and a variety of other objects, and because of their ability to swallow relatively large objects, they are highly susceptible to gastrointestinal obstruction.

Ingesting linear foreign bodies can be especially dangerous. A linear foreign body may be a piece of thread, nylon stocking, rope, string, carpet etc., and can cause a unique form of obstruction. One end of the body is usually lodged around the tongue, or in the pylorus, stomach or proximal small intestine, while the other end continues to travel through the intestines. The material can become tightly stretched such that the intestine progressively gathers itself into an accordion-like pattern, otherwise referred to as ‘plication’. With the intestines in this gathered state, blood flow may be compromised, and the intestines become very friable. The linear foreign body can also serrate through the intestinal wall, spilling intestinal contents into the abdomen and causing serious infection. Such an infection in the abdomen is known as ‘peritonitis’, and is in itself a life threatening emergency.

The consumption of linear foreign bodies thus often leads to very serious gastro-intestinal obstructions, often requiring immediate emergency surgical attention.

### SUMMARY OF THE INVENTION

It is therefore an object of the invention to provide accessories or products for animals, such as beds, absorbent pads, toys and the like, that are safer to consume and that reduce or prevent gastrointestinal obstructions or other complications associated with linear foreign bodies.

Accordingly, as an aspect of the invention, there is provided an animal accessory to prevent complications associated with consuming linear foreign bodies, wherein the animal accessory is a bed comprising:
an interior cushioning portion; and
an outer layer which covers and defines an outer surface of the interior cushioning portion, including top, side and bottom surface portions,
wherein the interior cushioning portion and the outer layer are made of a semi- to fully digestible material.

In certain embodiments, which are non-limiting, the outer layer may comprise cellulose wadding. In addition, the animal bed may optionally further comprise an inner moisture resistant layer that covers either the top, or the entirety of the interior cushioning portion.

The interior cushioning portion, in other non-limiting embodiments, may be a stuffing material comprising recycled paper based stuffing, and may optionally further comprise additional agents such as a chew deterrent scent, a freshening agent, or a combination thereof throughout the stuffing material.

The inner moisture resistant layer, in further non-limiting embodiments, may comprise waxed kraft paper or paraffin paper.

As a further option, the animal accessory may also comprise a removable pocket cover for covering the animal bed. In such embodiments, the removable pocket cover may be fabricated using a cellulose wadding material. The removable pocket cover may also comprise a pocket-type opening through which the animal bed may be inserted.

In certain further embodiments, the interior cushioning portion, the optional inner moisture resistant layer and the outer layer may be glued and/or stitched together using a non-toxic adhesive, incremental stitching of a material which is semi- to fully digestible, or a combination of both.

Also provided herein is an animal accessory to prevent complications associated with consuming linear foreign bodies, wherein the animal accessory is an absorbent pad, or puppy pad, comprising
a top absorbent layer; and
a bottom moisture resistant layer affixed to the top absorbent layer;
wherein the top absorbent layer and the bottom moisture resistant layer are made of a semi- to fully digestible material.

In embodiments of the above animal accessory, which are non-limiting, the top absorbent layer may comprise cellulose wadding. In addition, the bottom moisture resistant layer may comprise a waxed kraft paper or paraffin paper. In addition, the top absorbent layer and the bottom moisture resistant layer may be glued and/or stitched together using a non-toxic adhesive, incremental stitching of a material which is semi- to fully digestible, or a combination of both.

In yet another aspect of the invention, a stitching method is provided for preparing an animal accessory which prevents complications from consuming linear foreign bodies, in which stitching of the accessory is carried out in increments safe for consumption by an animal, and using a stitching material which is semi- to fully digestible.

In certain non-limiting embodiments, the stitching material may comprise hemp twine or chromic gut suturing. In addition, the stitching increment may be defined by a length of approximately 1.5 inches or less, or between 0.5 to 1.0 inches, or even less such as about 0.5 inches. The stitching increment may also be defined by a length between stitch increments which is sufficient to obtain adequate layer closure.

### BRIEF DESCRIPTION OF THE DRAWINGS

These and other features of the invention will become more apparent from the following description in which reference is made to the appended drawings wherein:

FIG. 1 shows a top view of an example of a pet bed, in accordance with an embodiment of the present invention, illustrated without a protective cover.

FIG. 2 shows a side view of the pet bed shown in FIG. 1.

FIG. 3 shows a top view of an example of a protective cover for use with the pet bed shown in FIG. 1.

FIG. 4 shows a view of the underside of the protective cover shown in

FIG. 3.

FIG. 5 shows a cross sectional view of the pet bed shown in FIG. 1, illustrating inner and outer layers thereof.

FIG. 6 shows an example of a stitching pattern, in accordance with an embodiment of the present invention, which can be incorporated throughout the structure of embodiments of the pet bed and protective cover shown in FIGS. 1 to 5, and/or specific layers or components thereof, as well as other embodiments of bedding, toys and the like.

FIG. 7 shows a top view of an example of a puppy pad, in accordance with a further embodiment of the present invention.

FIG. 8 shows a cross-sectional view of the puppy pad shown in FIG. 7.

### DETAILED DESCRIPTION

The consumption of regular bedding material by animals often leads to partial or full gastro-intestinal obstructions. Materials of particular concern are linear foreign bodies, such as long threads and strands of fabric or other materials used in most blankets and bedding, which can result in added harm and very serious complications if ingested.

As a veterinarian, the present inventor typically sees animals on a weekly basis that have ingested foreign materials. Some of these animals may evacuate the material on their own (via oral or fecal route), but frequently require more aggressive care and hospitalization, often requiring expensive surgical interventions. The cost for diagnostics alone can be quite substantial and leaves many owners in a very difficult predicament.

Young animals are especially prone to ingesting foreign materials, as are animals with anxiety or a history of chewing/eating foreign material. For this reason, many pet owners resort to leaving their pets (often puppies) with no bedding in a kennel fearing they may ingest the bedding material. Some animals may only destroy their bedding or leave it soiled (e.g. in the case of young, untrained pets or older incontinent pets, etc.) without ingesting it, although in either case frequent replacement can become costly.

To address these problems, the present inventor has developed a method of fabricating animal or pet accessories or products, such as beds, puppy pads, pet toys and the like which are safer to ingest than traditional products, and that are particularly designed to prevent complications associated with consuming linear foreign bodies.

In embodiments of the present invention, products such as animal beds, bedding, toys and the like are produced using semi- or fully digestible materials such as, but not limited to, paper, cellulose, or other digestible or consumable material that does not form linear foreign bodies. Semi- to fully digestible materials may vary widely, ranging from materials that can be partly or even fully digested by the gastrointestinal system, to materials that may not be digestible per se but are otherwise inert, non-toxic and can pass through the gastrointestinal (GI) tract without forming harmful linear foreign bodies. As one non-limiting example of a semi- or fully digestible material, brown paper is typically about 40 to 60% digestible (or broken down) in the GI tract. Other paper materials are up to 98% digestible. As with many fibrous plant-based materials, the plant cell walls are not always fully broken down, but can pass through the gastrointestinal tract without problem.

In preferred embodiments, yet without wishing to be limiting, the semi- or fully digestible materials used in the products and methods described herein will preferably be non-toxic, environmentally friendly, and recyclable. Thus, in such preferred embodiments, any printing or images on the products will utilize non-toxic ink, such as but not limited to, soy or other plant-derived inks. Any adhesives used in these products should also be non-toxic.

Also provided herein are products which, in further non-limiting embodiments, are produced as cost effective alternatives to more expensive beds, bedding, toys and the like, including disposable products. Water resistant protective coverings, including covers for animal beds and the like, are also provided and which can be employed to increase longevity of, e.g. an animal bed.

In addition, a unique stitching method is also described herein for use in the process of fabricating the products herein, and which is adapted to prevent consumption of linear foreign bodies. In particular, a stitching method and pattern is described in which the stitching of the product is carried out in increments at variable lengths, without using long continuous stitching on any aspect of the product. This stitching method and pattern can be incorporated into beds, bedding, pads, toys or any other animal product that may require stitching.

The invention will now be described in further detail with reference to the appended drawings.

FIGS. 1, 2 and 5 illustrate an example of an animal bed 10, in accordance with one non-limiting embodiment of the present invention. The animal bed 10 may be produced in any shape or form, including the common ‘round’ or ‘donut’ shaped bed as shown, may be rectangular or a bolster-type variety, or any other animal bed as would be apparent to one of ordinary skill in the art. Thus, the present invention may be adapted to a wide range of pet beds, pads, or even toys and other products that could be chewed and ingested by a pet or other animal. As shown, the illustrated bed comprises an outer layer 15, and also includes an optional inner layer 20 which is moisture resistant. The outer layer 15 is made of a semi- to fully digestible material such as, but not limited to, cellulose wadding, and covers the entirety of the animal bed 10 and defines an outer surface of the interior cushioning portion 25, including top, side and bottom surface portions. Cellulose wadding is typically derived from recycled paper, and commonly used as a packaging material. Cellulose wadding is also available in large rolls, has cushioning properties, and is thus a particularly useful layering material to be used in, e.g. animal bedding.

The interior portion 25 of the animal bed is generally filled with a stuffing material that is also semi- to fully digestible. In certain embodiments, which are not intended to be limiting, the stuffing material in the interior portion 25 of animal bed 10 is also non-toxic, and may optionally also include a chew deterrent scent throughout the stuffing material. For example, the chew deterrent may comprise, without limitation, citrus scent, bitter apple, small cedar chips, or other non-toxic agents to deter chewing. Baking soda or other freshening agents may also be added to the stuffing material, if desired. Regarding the stuffing material itself, it is intended that any semi- to fully digestible material can be used which provides a soft, bulky consistency, such as but not limited to recycled paper based bedding. This particular type of bedding is often used to house small pocket pets such as hamsters, and is widely available.

As illustrated, the animal bed 10 may also comprise an optional inner layer 20 which acts as a moisture barrier or is at least moisture resistant. As shown in FIG. 5, the inner layer 20 is provided over the entire inner surface of the animal bed 10, separating the outer layer 15 which covers the animal bed 10 from the interior 25, but can also be applied only on the top of the bed, or the top and side portions. Without wishing to be limiting, it is intended that the inner layer 20 will be made of a material that is also semi- to fully digestible, such as waxed kraft paper, or paraffin paper. This same material may also be used to form the bottom/underside layer 22 of the animal bed.

An optional pocket cover 30, as illustrated in FIGS. 3 and 4, may also be provided as a component of the animal bed 10. In certain embodiments, the pocket cover 30 may be disposable. The pocket cover 30 may vary in shape, typically to match the particular shape and dimensions of the animal bed 10. However, it is intended that the pocket cover 30 will not include any zippers or similar non-digestible material. The pocket cover may be a single layer of material, for example a layer of material similar to the outer layer 15 of bed 10, or may also optionally include a moisture resistant layer similar to inner layer 20. Thus, the pocket cover may be fabricated with a pocket-type opening 35 such as that illustrated in FIG. 4, or any other opening, through which the animal bed may be inserted within the pocket cover 30 and thus protected from wear and/or moisture.

The materials used in the animal bed illustrated in FIGS. 1 to 5 may be glued or stitched together, or a combination of both. However, any stitching used in the construction of the animal bed 10, pocket cover 30, or other products as described herein, should utilize the increment stitching technique described below and illustrated in FIG. 6. In addition, the stitching material, if used, should be a semi- to fully digestible material as described herein. For example, yet without being limiting in any manner, the stitching material may be hemp twine, gut suture, or other bioabsorbable suture materials. If using chromic gut (catgut) suturing, 2-0 or -0 is particularly envisioned (with 2-0 and 0 being diameter size of the suture material). Adhesives used in constructing such products should be non-toxic.

Referring to FIG. 6, the stitching technique to be employed in the products provided herein, including the animal bed 10 or any other product as contemplated by the present invention, does not use continuous stitching since long threads can give rise to linear foreign bodies when ingested. Instead, stitching is carried out in increments 40, with varying length A per stitch as well as varying length B between stitches. The particular lengths A and B will depend on the size of the product, e.g. animal bed, puppy pad, etc., and the target population (e.g. a small bed for small dogs, vs. large bed for larger dogs). Generally, it is preferred for the length of the stitch increment A to be 1.5 inches or less for animals over 20 lbs, to avoid consumption of materials of any significant length. For smaller animals, a shorter stitch increment may desirable, e.g. 0.5 inches for animals under 20 lbs. Thus, the stitch increment A may be any length that is safe for consumption by an animal of particular size, typically 1.5 inches, 1.0 inches, 0.5 inches, or even less depending on the target animal. The length B between stitch increments is based upon the thickness of the product, such as the animal bed, puppy pad, toy, etc., to obtain adequate layer closure. For example, it is generally desirable for water repellant layers to have shorter lengths B in between stitch increments to ensure a better protective seal from moisture. If needed, it is also intended that the use of double stitching, or multiple stitching patterns may be used to reduce permeability and/or increase strength of the adhesion. Combinations of adhesives and stitching may also be used.

Puppy pads and other absorbent pads/layering are also envisioned, including the example of a puppy pad 50 illustrated in FIGS. 7 and 8. In general, this type of product does not require padding or stuffing material between layers since it is primarily intended to absorb/capture fluids. The materials used for a product of this type, including the puppy pad 50 illustrated in FIGS. 7 and 8, will therefore be similar to the outer 15 and inner 20 layers of the animal bed 10 illustrated in FIGS. 1 to 5.

Referring specifically to the example illustrated in FIGS. 7 and 8, the puppy pad 50 includes a top absorbent layer 55 and a bottom layer 57 which acts as a moisture barrier or is at least moisture resistant. Similar to outer layer 15 of the animal bed 10, the top absorbent layer 55 of puppy pad 50 is made of a semi- to fully digestible material such as, but not limited to, cellulose wadding. The bottom layer 57 of puppy pad 50 is similar to the inner layer 20 of the animal bed 10, and is also made of a material that is semi- to fully digestible including but not limited to waxed kraft paper, or paraffin paper. The two layers may be glued or stitched together to form a unitary pad with a top absorbent layer and bottom moisture barrier layer, using either a non-toxic adhesive, the stitching technique described above, or combinations thereof.

In further embodiments of the present invention, semi- to fully digestible materials as described herein may also be used to produce animal toys (not shown). For example, toys such as twisted paper rope toys, balls, etc. are envisioned.

One or more currently preferred embodiments have been described by way of example. It will be apparent to persons skilled in the art that a number of variations and modifications can be made without departing from the scope of the invention as defined in the claims.

1. An animal accessory to prevent complications associated with consuming linear foreign bodies, wherein the animal accessory is a bed 10 comprising an interior cushioning portion 25; and
an outer layer 15 which covers and defines an outer surface of the interior cushioning portion 25, including top, side and bottom surface portions, wherein the interior cushioning portion 25 and the outer layer 15 are made of a semi- to fully digestible material.

2. The animal accessory of claim 1, further comprising an inner moisture resistant layer 20 which protects at least a top surface of interior cushioning portion 25 from moisture, and which is made of a semi- to fully digestible material.

3. The animal accessory of claim 1, wherein the outer layer 15 comprises cellulose wadding.

4. The animal accessory of claim 2, wherein the inner moisture resistant layer 20 covers the entirety of the interior cushioning portion 25.

5. The animal accessory of claim 1, wherein the interior cushioning portion 25 is a stuffing material comprising recycled paper based stuffing.

6. The animal accessory of claim 5, wherein the interior cushioning portion 25 further comprises a chew deterrent scent, a freshening agent, or a combination thereof throughout the stuffing material.

7. The animal accessory of claim 2, wherein the inner moisture resistant layer 20 comprises waxed kraft paper or paraffin paper.

8. The animal accessory of claim 1, further comprising a removable pocket cover 30 covering the animal bed 10.

9. The animal accessory of claim 8, wherein the removable pocket cover 30 comprises a cellulose wadding material.

10. The animal accessory of claim 8, wherein the removable pocket cover 30 comprises a pocket-type opening 35 through which the animal bed may be inserted.

11. The animal accessory of claim 2, wherein the interior cushioning portion 25, the inner moisture resistant layer 20 and the outer layer 15 are glued and/or stitched together using a non-toxic adhesive, incremental stitching of a material which is semi- to fully digestible, or a combination of both.

12. The animal accessory of claim 1, which is disposable.

13. An animal accessory to prevent complications associated with consuming linear foreign bodies, wherein the animal accessory is a puppy pad 50 comprising a top absorbent layer 55; and
a bottom moisture resistant layer 57 affixed to the top absorbent layer 55;
wherein the top absorbent layer 55 and the bottom moisture barrier layer 57 are made of a semi- to fully digestible material.

14. The animal accessory of claim 13, wherein the top absorbent layer 55 comprises cellulose wadding.

15. The animal accessory of claim 13, wherein the bottom resistant barrier layer 57 comprises waxed kraft paper or paraffin paper.

16. The animal accessory of claim 13, wherein the top absorbent layer 55 and the bottom moisture resistant layer 57 are glued and/or stitched together using a non-toxic adhesive, incremental stitching of a material which is semi- to fully digestible, or a combination of both.

17. A stitching method for preparing an animal accessory which prevents complications from consuming linear foreign bodies, in which stitching of the accessory is carried out in increments safe for consumption by an animal, and using a stitching material which is semi- to fully digestible.

18. The stitching method of claim 17, wherein the stitching material is hemp twine or chromic gut suturing.

19. The stitching method of claim 17, wherein the stitching increment is defined by a length A of 1.5 inches or less.

20. The stitching method of claim 17, wherein the stitching increment is defined by a length A of 0.5 to 1.0 inches.

21. The stitching method of claim 17, wherein the stitching increment is defined by a length A of about 0.5 inches.

22. The stitching method of claim 17, wherein the stitching increment is defined by a length B between stitch increments which is sufficient to obtain adequate layer closure.
